(19) United States
(12) Patent Application Publication
(10) Pub. No.: US 2025/0325359 A1
(43) Pub. Date: Oct. 23, 2025

(54) METHOD FOR PREPARING MOUSE MODEL IN WHICH DRUGS ARE ADMINISTRATED VIA HEPATIC ARTERY INFUSION AND APPLICATION THEREOF

(71) Applicant: SUN YAT-SEN UNIVERSITY CANCER CENTER (SYSUCC), GUANGZHOU (CN)

(72) Inventors: MING ZHAO, GUANGZHOU (CN); NING LYU, GUANGZHOU (CN); JIONGLIANG WANG, GUANGZHOU (CN); QIFENG CHEN, GUANGZHOU (CN); XIONGYING JIANG, GUANGZHOU (CN); SONG CHEN, GUANGZHOU (CN); YUE HU, GUANGZHOU (CN)

(21) Appl. No.: 18/959,927

(22) Filed: Nov. 26, 2024

(30) Foreign Application Priority Data
Apr. 17, 2024 (CN) 202410458769.1

(51) Int. Cl. A61D 7/00

(52) U.S. Cl. CPC A61D 7/00

(57) ABSTRACT

A method for preparing a mouse model in which drugs are administrated via hepatic artery infusion includes fixing a mouse in a lateral position after being anesthetized, opening an abdominal cavity of the mouse layer by layer, freeing and exposing celiac artery, ligating two branches of the celiac artery except a common hepatic artery by making slipknots thereon by sterile sutures under an animal microscope, puncturing the celiac artery to make an opening by a 34G syringe, fixing a short segment of an L-shaped microcatheter in the sterile sutures, connecting a tail end of a long segment of the L-shaped microcatheter to a 1 ml syringe, injecting the drugs through the L-shaped microcatheter, removing the L-shaped microcatheter, pressing the opening of the celiac artery with gelatin sponge for hemostasis, removing all of the sterile sutures after above operations are completed.

### TECHNICAL FIELD

The present disclosure relates to a technical field of preparation of drug administration animal models, and in particular to a method for preparing a mouse model in which drugs are administrated via hepatic artery infusion and an application thereof.

### BACKGROUND

In actual clinical treatment of advanced hepatocellular carcinoma (HCC), hepatic artery infusion chemotherapy (HAIC-FO, which is a combination chemotherapy of oxaliplatin, folinic acid, and fluorouracil) is proven to be an effective treatment method. In basic scientific research, mice are the most commonly used animals for preparing animal models. However, a hepatic artery of the mice is small, making it difficult to catheterize and administer drugs to the common hepatic artery of the mice. Currently, New Zealand rabbits, Sprague-Dawley (SD) rats, etc. are selected to prepare HAIC-FO models/drug administration models. In New Zealand rabbit models and SD rat models, drugs are administered through cannulation of the hepatic artery thereof, which is relatively cumbersome due to a large size of the New Zealand rabbit models and the SD rat models.

Although the New Zealand rabbit models and the SD rat models provide a corresponding animal model research basis for studying HAIC-FO/drug administration, they have the following defects.

Firstly, the New Zealand rabbit models and the SD rat models have a problem in genetic background heterozygosity. Genetic characteristics of the New Zealand rabbits and the SD rats are relatively unstable. The New Zealand rabbits and the SD rats belong to closed group animals (outbred lines) and maintain a certain degree of genetic heterozygosity. Therefore, the genetic characteristics of the New Zealand rabbits and the SD rats are not as stable as the mice. Therefore, the New Zealand rabbit models and the SD rat models are not conducive to conducting genetic-related treatment research, and experimental reproducibility is poor.

Secondly, the New Zealand rabbit models lack genomic information, making the New Zealand rabbit models difficult to conduct in-depth research. Full genome information of the New Zealand rabbits has not yet been fully revealed, and genomic information of the New Zealand rabbits is quite different from that of humans. Therefore, the New Zealand rabbit models are not conducive to development of basic medical research related to genetics.

Thirdly, the New Zealand rabbit models and the SD rat models lack antibodies and drugs required for basic medical research. A large number of antibodies and drugs required for basic medical research are mostly designed for genes of human or the mice. Currently, there are only a very small number of corresponding antibodies and drugs available for the New Zealand rabbits and the SD rats on the market, which seriously limits the research of preclinical animal models.

Finally, the New Zealand rabbits and the SD rats have a long maturation period, require a large breeding space, are difficult to manage. Moreover, an experiment therefor takes a long time. A maturation period of the New Zealand rabbits is 5-8 months, a maturation period of the SD rats is 2-3 months, and a maturation period of the mice is 1.5-2 months. Compared with the mice, experimental time required for the New Zealand rabbits and the SD rats is longer. Compared with the mice, the New Zealand rabbits and the SD rats require more space to be raised and have higher breeding and management costs, making it difficult to conduct large-scale experiments in a short period of time.

A successful construction of HAIC-FO mouse models may better overcome the defects of the HAIC-FO model prepared by the Zealand rabbits and the SD rats. The mice are inbred animals with a single genetic background, highly stable genetics, highly homozygous genes, and clear genetic background information. In addition, the whole genome DNA sequencing of the mice was completed in 2003. A similarity between the mouse genome and the human genome is as high as 80%, which is suitable for basic research related to genetics and genomics, and phenotype is highly reproducible. In addition, most of antibodies and drugs currently circulating on the market are designed for corresponding targets of the mice, which meet a basic research of drug administration of the mice via hepatic artery infusion, especially for study of tumor microenvironment and tumor immunity. The mice have a short maturation period, low breeding costs, and small living space, which are conducive to experimental development. Therefore, a preparation of a mouse model in which drugs are administrated via hepatic artery infusion fully meets the preclinical basic research drug administration via hepatic artery infusion, which is conducive to explorations of genetics, tumor immunology, etc., and fills corresponding technical gaps.

Therefore, the present disclosure provides a method for preparing a mouse model in which drugs are administrated via hepatic artery infusion and an application thereof to solve technical problems in the prior art.

### SUMMARY

The present disclosure provides a method for preparing a mouse model in which drugs are administrated via hepatic artery infusion and an application thereof to solve technical problems in the prior art.

The method comprises following steps:
step S1: selecting a mouse in good health;
step S2: anesthetizing the mouse with isoflurane, spreading out and fixing limbs of the mouse in a lateral position, and performing a notch processing on the mouse;
step S3: opening an abdominal cavity of the mouse via an abdominal opener, and carrying out surgery on the mouse under an animal microscope;
step S4: using sterile sutures to make slipknot ligature on two branches of a celiac artery except a common hepatic artery of the celiac artery, winding the sterile sutures around a proximal end of the celiac artery and pulling up the sterile sutures to temporarily block a blood flow, puncturing along celiac artery to make an opening, and inserting a short segment of a catheter in the celiac artery;
step S5: fixing the short segment of the catheter in the celiac artery by making a slipknot on the catheter via the sterile sutures, connecting a tail end of a long segment of the catheter to a 1 ml syringe, and injecting the drugs through the catheter; and
step S6: after the step S5 is completed, flushing the catheter by physiological saline, removing the catheter, removing all of the sterile sutures; pressing the opening of the celiac artery with gelatin sponge for 1 minute for hemostasis, closing an abdominal muscular layer and a skin layer in sequence, and ending the surgery after disinfection.

Optionally, in the step S2, performing the notch processing on the mouse comprises making a 1-cm skin and muscle incision 0.5 cm below ribs of the mouse and perpendicular to a long axis of a body of the mouse.

Optionally, in the step S3, carrying out the surgery on the mouse under the animal microscope comprises:
spreading apart a spleen of the mouse, and exposing the celiac artery with an adrenal gland as an anatomical landmark;
freeing and exposing along the celiac artery to expose three branches of the celiac artery, where the three branches comprise the common hepatic artery, a pancreatic-splenic artery, and a splenic-gastric artery; and
ligating the pancreatic-splenic artery and the splenic-gastric artery.

Optionally, in the step S4, placing the catheter in the opening comprises inserting the short segment of the catheter into the opening along the blood outflow tract of the celiac artery after puncturing the celiac artery with a needle of a 34G syringe. The catheter is an L-shaped microcatheter.

Optionally, in the step S5, the drugs are injected according to a weight of the mouse, the drugs comprise oxaliplatin and 5-fluorouracil, a dose of the oxaliplatin is 5 mg/kg, and a dose of the 5-fluorouracil is 15 mg/kg.

The present disclosure further provide the application. The application comprises applying the method in preparing preclinical animal models.

Compared with the prior art, in the present disclosure, a construction procedure of the mouse model is simple, accurate and safe. Physiological structural damage caused by the surgery is able to be recovered after the surgery, which reduces an impact of the physiological structural damage on survival of the mouse and avoids affecting an effect of the mouse model. Moreover, the mouse model effectively simulates a therapeutic effect of the drugs infused into a liver or liver tumors through a hepatic artery in the human body, and thus being used to reveal a basic mechanism of hepatic artery infusion chemotherapy/drug administration.

### BRIEF DESCRIPTION OF DRAWINGS

The present disclosure contains at least one drawing executed in color, which is for illustrative purpose only and forms no part thereof.

FIG. 1 is a flow chart of a method for preparing a mouse model in which drugs are administrated via hepatic artery infusion of the present disclosure, where A is am image showing that a mouse in a lateral position to expose an abdominal cavity for performing a surgery, B is an image showing that a catheter is placed in a celiac artery of the mouse, C is an enlarged image showing that the catheter is placed in the celiac artery, D is am image showing that the catheter is placed in the celiac artery and blood returning in the catheter under an animal microscope; E is an image showing that a pancreatic-splenic artery and a splenic-gastric artery are ligated and the catheter is fixed under the animal microscope; F is an image showing that a liver of the mouse is stained after methylene blue is injected into the mouse via the catheter; G is an image showing that the liver is stained by the methylene blue.

FIG. 2 is a schematic diagram of a comparison of liver tumors in different mice under different administration methods of the present disclosure.

FIG. 3 is a schematic diagram of the catheter of the present disclosure.

FIG. 4 is a schematic diagram of a comparison of a liver/body weight ratio and a terminal body weight of different mice under different administration methods of the present disclosure.

FIG. 5 is a schematic diagram of a comparison of a quantity of peripheral blood leukocytes and lymphocytes in different mice under different administration methods of the present disclosure.

FIG. 6 is a schematic diagram of a comparison of liver tumor necrosis of different mice under different administration methods of the present disclosure.

### DETAILED DESCRIPTION

Following embodiments of the present disclosure are described in detail in conjunction with accompanying drawings and examples. Following examples are used to illustrate the present disclosure, but are not intended to limit the scope of the present disclosure.

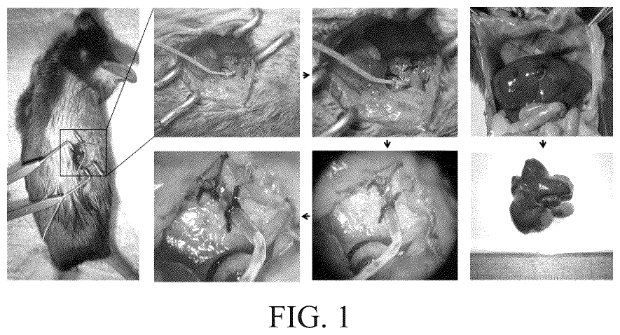

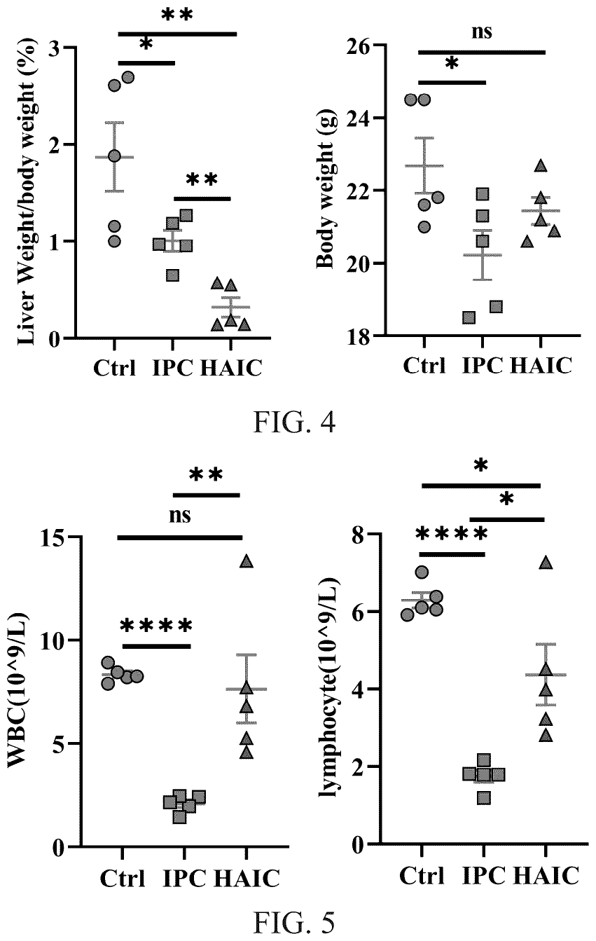

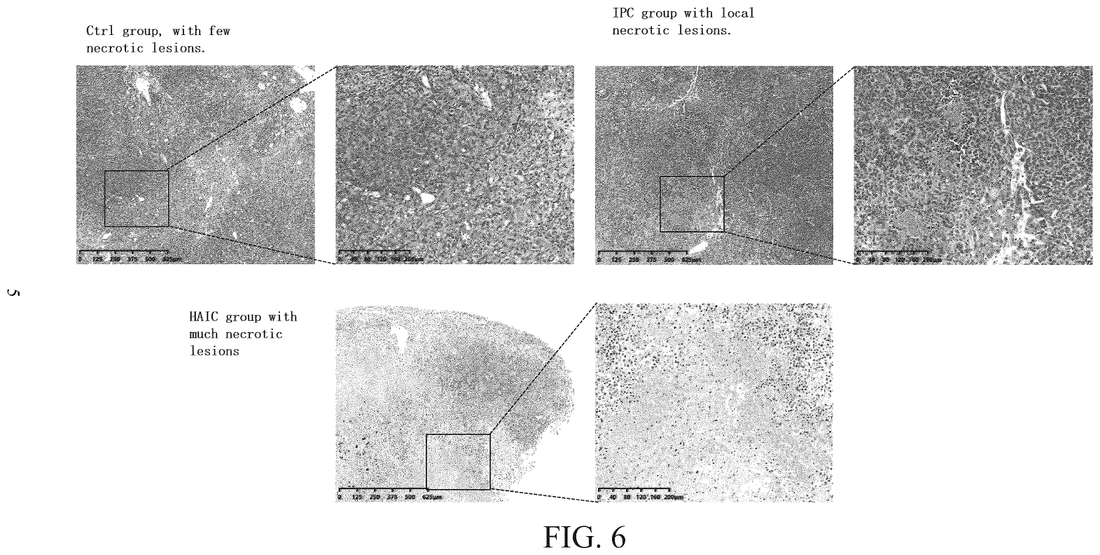

As shown in FIGS. 1-6, the present disclosure provides a method for preparing a mouse model in which drugs are administrated via hepatic artery infusion. The method comprises steps S1-S6.

The step S1 comprises selecting a mouse in good health.

The step S2 comprises anesthetizing the mouse with isoflurane, spreading out and fixing limbs of the mouse in a lateral position, and making a 1-cm skin and muscle incision 0.5 cm below ribs of the mouse and perpendicular to a long axis of a body of the mouse.

The step S3 comprises opening an abdominal cavity of the mouse via an abdominal opener, and carrying out surgery on the mouse under an animal microscope. Specifically, a spleen of the mouse is spread apart, a celiac artery is exposed with an adrenal gland as an anatomical landmark, and the celiac artery is freed and exposed to expose three branches of the celiac artery. The three branches comprise the common hepatic artery, a pancreatic-splenic artery, and a splenic-gastric artery.

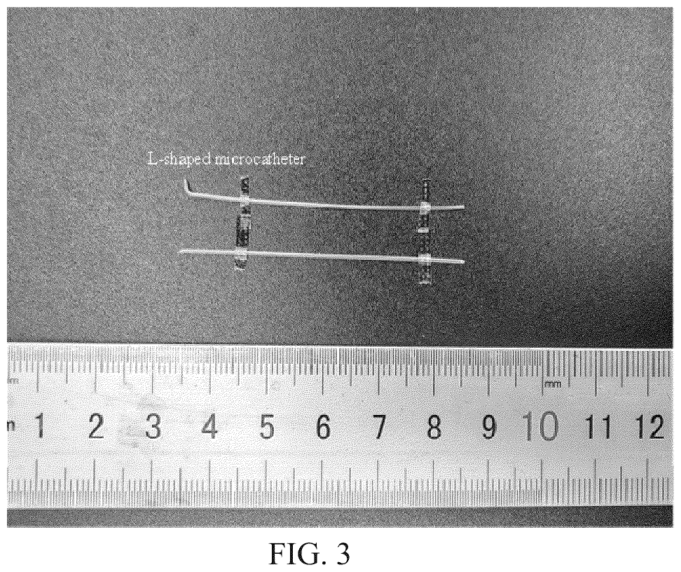

The step S4 comprises using sterile sutures to make slipknot ligature on the pancreatic-splenic artery and the splenic-gastric artery of the celiac artery except the common hepatic artery of the celiac artery, winding the sterile sutures around a proximal end of the celiac artery and pulling up the sterile sutures to temporarily block a blood flow, puncturing along a direction of a blood outflow tract of the celiac artery with a needle of a 34G syringe to make an opening, and placing a catheter in the opening. Specifically, the short segment of the catheter is inserted into the opening along the blood outflow tract of the celiac artery. The catheter is an L-shaped microcatheter as shown in FIG. 3.

The step S5 comprises fixing a short segment of the catheter in the celiac artery by making a slipknot on the catheter via the sterile sutures, connecting a tail end of a long segment of the catheter to a 1 ml syringe, and injecting the drugs through the catheter. For instance, when preparing a hepatic artery infusion chemotherapy (HAIC) mouse model, the drugs are injected according to a weight of the mouse, and the drugs comprise oxaliplatin and 5-fluorouracil. Specifically, a dose of the oxaliplatin is 5 mg/kg, and a dose of the 5-fluorouracil is 15 mg/kg.

The step S6 comprises after the step S5 is completed, flushing the catheter by physiological saline, removing the catheter, removing all of the sterile sutures; pressing the opening of the celiac artery with gelatin sponge for 1 minute for hemostasis, closing an abdominal muscular layer and a skin layer in sequence, and ending the surgery after disinfection.

To sum up, in the present disclosure, a construction procedure of the mouse model is simple, accurate and safe. Physiological structural damage caused by the surgery is able to be recovered after the surgery, which reduces an impact of the physiological structural damage on survival of the mouse and avoids affecting an effect of the mouse model. Moreover, the mouse model effectively simulates a therapeutic effect of the drugs infused into a liver or liver tumors through a hepatic artery in the human body, and thus being used to reveal a basic mechanism of hepatic artery infusion chemotherapy/drug administration.

### Embodiment 1

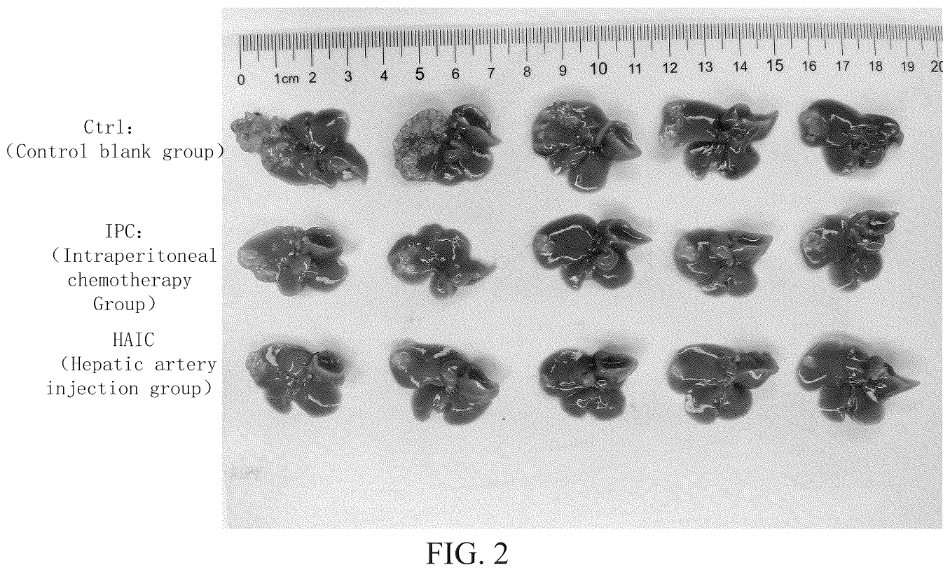

Three groups of mice are provided for experiment. A first group thereof comprises five HAIC mouse models prepared by the method mentioned above. A second group thereof comprises five mouse models that are intraperitoneally administrated. A third group thereof comprises two mice that are not administrated. That is, the third group is a control group. As shown in FIGS. 2, 4, and 6, it is noted that in different administration methods, the HAIC mouse models of the first group perform best situations of liver tumors, a liver/body weight ratio, a terminal body weight, a quantity of peripheral blood leukocytes and lymphocytes, and liver tumor necrosis. The HAIC mouse models effectively simulate therapeutic effects of drug infusion into a liver or liver tumors via a hepatic artery of a human body, and HAIC mouse models are also used to reveal the basic mechanism of the effectiveness of HAIC/drug administration.

### Embodiment 2

The HAIC mouse models are used to explore an application of nanomaterials in the body thereof. Specifically 12 mice are select and each mouse is process as follow.

Preoperative preparation: First, each mouse is fasted for 12 hours before the surgery, but each mouse is allowed to drink water freely. Then, each mouse is anesthetized with 1% sodium pentobarbital at a dose of 10 ml/kg. After each mouse is successfully anesthetized, each mouse is spread out in a lateral position on an operating table and the limbs of each mouse are fixed with tape. Then, hair on a chest and the abdomen of each mouse is removed, and a surgical area of each mouse is disinfected with iodine.

Surgical procedure: Making a 1-cm skin and muscle incision 0.5 cm below ribs of each mouse and perpendicular to the long axis of the body of each mouse to open the abdominal cavity of each mouse. Then, the abdominal cavity of each mouse is opened via the abdominal opener to expose the celiac artery of each mouse with the adrenal gland thereof as the anatomical landmark. The celiac artery and the three branches of the celiac artery are freed and exposed along the blood outflow tract of the celiac artery. The pancreatic-splenic artery and the splenic-gastric artery are ligated through making slipknots thereon via the sterile sutures. The celiac artery is punctured with the needle of the 34G syringe to make the opening along the blood outflow tract of the celiac artery of each mouse. Then, the short segment of the L-shaped microcatheter is placed into the celiac artery, and the tail end of the long segment of the L-shaped microcatheter is connected to the 1 ml syringe. The nanomaterials are injected through the hepatic artery. After the injection is completed, the opening of the celiac artery is pressed with the gelatin sponge for hemostasis, all of the sterile sutures are removed, the abdominal muscular layer and the skin layer are closed in sequence to close the 1-cm skin and muscle incision, so as to complete the surgery.

Postoperative care and observation: After each mouse wakes up, put each mouse back into a breeding room for feeding, and then pay close attention to a condition and survival status of each mouse and make relevant records.

Application in drug metabolism research: After the mouse models are successfully prepared, blood samples or other biological samples (such as urine, tissues, etc.) are collected at different time points to analyze changes in a concentration of the nanomaterials and metabolites thereof.

By comparing pharmacokinetic parameters (such as drug clearance, half-life, etc.) at different time points of different mouse models, it is found that the drugs have good metabolic characteristics and pharmacodynamics in the mouse models. Specifically, following effects are obtained.

1) The mouse models are used to study metabolic pathways of the drugs in the liver, a formation rate of the metabolites, and excretion pathways.

2) The mouse models are used to evaluate pharmacodynamic properties of the drugs in the liver, such as pharmacodynamic properties of anti-tumor drugs and pharmacodynamic properties of toxic drugs.

3) The mouse models are used to study pharmacokinetic properties of the drugs in the liver, such as absorption, distribution, metabolism, and excretion of the drugs.

In summary, in the present disclosure, the construction procedure of each mouse model is simple, accurate and safe. The physiological structural damage caused by the surgery is able to be recovered after the surgery, which reduces an impact of the physiological structural damage on survival of each mouse and avoids affecting the effect of each mouse model. Moreover, each mouse model effectively simulates the therapeutic effect of the drugs infused into the liver or the liver tumors through the hepatic artery in the human body, and thus being used to reveal the basic mechanism of the common hepatic artery infusion chemotherapy/drug administration. The present disclosure is able to provide proper animal models for preclinical research on HAIC/drug administration, especially for studying local liver microenvironment and tumor immune microenvironment after HAIC/drug administration, which is no longer limited by limitations of New Zealand rabbit models and SD rat models due to lack of corresponding antibodies and drugs.

The embodiments of the present disclosure are provided for the purpose of illustration and description. Although the embodiments of the present disclosure are shown and described above, it is understood that the above embodiments are exemplary and cannot be understood as limitations of the present disclosure. Those skilled in the art are bale to change, modify, replace, and modify the above embodiments within the scope of the present disclosure.

What is claimed is:

1. A method for preparing a mouse model in which drugs are administrated via hepatic artery infusion, comprising following steps:
step S1: selecting a mouse in good health;
step S2: anesthetizing the mouse with isoflurane, spreading out and fixing limbs of the mouse in a lateral position to fix them, and performing a notch processing on the mouse;
step S3: opening an abdominal cavity of the mouse via an abdominal opener, and carrying out surgery on the mouse under an animal microscope;
step S4: using sterile sutures to make slipknot ligature on two branches of a celiac artery except a common hepatic artery of the celiac artery, winding the sterile sutures around a proximal end of the celiac artery and pulling up the sterile sutures to temporarily block a blood flow, puncturing along a direction of a blood outflow tract of the celiac artery to make an opening, and placing a short segment of a catheter in the celiac artery along the direction of the blood outflow tract;
step S5: fixing a short segment of the catheter in the celiac artery by making a slipknot on the catheter via the sterile sutures, connecting a tail end of a long segment of the catheter to a 1 ml syringe, and injecting the drugs through the catheter; and
step S6: after the step S5 is completed, flushing the catheter by physiological saline, removing the catheter, removing all of the sterile sutures; pressing the opening of the celiac artery with gelatin sponge for 1 minute for hemostasis, closing an abdominal muscular layer and a skin layer in sequence, and ending the surgery after disinfection.

2. The method according to claim 1, wherein in the step S2, performing the notch processing on the mouse comprises making a 1-cm skin and muscle incision 0.5 cm below ribs of the mouse and perpendicular to a long axis of a body of the mouse.

3. The method according to claim 1, wherein in the step S3, carrying out the surgery on the mouse under the animal microscope comprises:
spreading apart a spleen of the mouse, and exposing the celiac artery with an adrenal gland as an anatomical landmark;
freeing and exposing along the celiac artery to expose three branches of the celiac artery, wherein the three branches comprise the common hepatic artery, a pancreatic-splenic artery, and a splenic-gastric artery; and
ligating the pancreatic-splenic artery and the splenic-gastric artery.

4. The method according to claim 1, wherein in the step S4, placing the catheter in the opening comprises inserting the short segment of the catheter into the opening along the blood outflow tract of the celiac artery after puncturing the celiac artery with a needle of a 34G syringe, wherein the catheter is an L-shaped microcatheter.

5. The method according to claim 1, wherein in the step S5, the drugs are injected according to a weight of the mouse, the drugs comprise oxaliplatin and 5-fluorouracil, a dose of the oxaliplatin is 5 mg/kg, and a dose of the 5-fluorouracil is 15 mg/kg.
